(19) United States
(12) Patent Application Publication
(10) Pub. No.: US 2019/0019206 A1
(43) Pub. Date: Jan. 17, 2019

(54) System, Method, and Computer Program Product for Determining Underserved Regions

(71) Applicant: Visa International Service Association, San Francisco, CA (US)

(72) Inventor: Gilbert Sy, Foster City, CA (US)

(21) Appl. No.: 16/033,405

(22) Filed: Jul. 12, 2018

Related U.S. Application Data
(60) Provisional application No. 62/532,074, filed on Jul. 13, 2017.

(51) Int. Cl. G06Q 30/02; G06Q 10/06; G06Q 40/02; G06F 17/30

(52) U.S. Cl. CPC G06Q 30/0205; G06F 17/30241; G06Q 40/02; G06Q 10/0637

(57) ABSTRACT

Provided is a computer-implemented method for determining underserved regions based on transaction data. The method includes receiving, with at least one processor, transaction data associated with a plurality of transactions conducted in a first region, generating, with at least one processor, at least one metric based at least partially on the transaction data, determining, with at least one processor and based at least partially on the at least one metric, that the first region is underserved, generating, with at least one processor, at least one score for the first region based at least partially on the at least one metric, and correlating, with at least one processor, the at least one score with demographic data or map data associated with the first region.

### CROSS REFERENCE TO RELATED APPLICATION

This application claims the benefit of U.S. Provisional Application No. 62/532,074, filed on Jul. 13, 2017, entitled “System, Method, and Computer Program Product for Determining Underserved Regions”, the entire content of which is hereby incorporated by reference.

### BACKGROUND OF THE INVENTION

### 1. Field of the Invention

This invention relates generally to identifying underserved regions and, in non-limiting embodiments, to a system, method, and computer program product for determining underserved regions based on transaction data.

### 2. Technical Considerations

Some geographic regions are underserved by various service providers and merchants, such as banks and grocery stores. Existing systems are unable to determine and provide improved services and options to consumers in such regions. At most, such regions can only be manually identified by economic experts using publically available information and guesswork. Any use of technological systems for identifying such regions and a degree to which such regions are underserved would, at most, store and organize manually inputted information.

From a merchant and service provider perspective, existing systems and available data can only provide an inaccurate view of the needs and demands of one or more regions. This limitation makes it difficult to determine regions that are underserved and to enhance and/or improve their offerings.

Accordingly, there is a need for a system, method, and computer program product for determining underserved regions based on transaction data.

### SUMMARY OF THE INVENTION

Accordingly, it is an object of the present invention to provide a system, method, and apparatus for authenticating a transaction that overcomes some or all of the deficiencies of the prior art.

According to a non-limiting embodiment, provided is a computer-implemented method for determining underserved regions based on transaction data, comprising: receiving, with at least one processor, transaction data associated with a plurality of transactions conducted in a first region; generating, with at least one processor, at least one metric based at least partially on the transaction data; determining, with at least one processor and based at least partially on the at least one metric, that the first region is underserved; generating, with at least one processor, at least one score for the first region based at least partially on the at least one metric; and correlating, with at least one processor, the at least one score with demographic data or map data associated with the first region.

In non-limiting embodiments of the method, determining the at least one metric comprises: determining a number of transactions in a category within the first region or conducted by account holders associated with the first region; determining a number of merchants within the first region that are associated with the category and are located within the first region; and generating the at least one metric based on the number of transactions and the number of merchants. In non-limiting embodiments, determining the at least one metric further comprises: determining a population in the first region; determining a number of merchants within the first region that are associated with a category and are located within the first region; and generating the at least one metric based on a ratio of the population to the number of merchants.

In non-limiting embodiments of the method, determining that the merchants are located within the first region comprises: correlating a geographic code embedded in transaction data from each merchant with a geographic boundary of the first region; or correlating merchant identifiers associated with transactions in the category with a merchant database associating merchant identifiers with geographic codes. In non-limiting embodiments, determining the at least one score for the first region comprises inputting, into a score generation algorithm, the number of transactions in the category and the number of merchants.

In non-limiting embodiments of the method, the at least one metric represents a number of merchants in the first region that correspond to a predetermined Merchant Category Code (MCC). In other non-limiting embodiments, the at least one metric represents a number of banks having a Bank Identification Number (BIN) corresponding to the first region.

According to another non-limiting embodiment, provided is a system for determining underserved regions based on transaction data, comprising at least one data storage device comprising transaction data; and at least one processor in communication with the at least one data storage device, the at least one processor programmed or configured to: receive transaction data associated with a plurality of transactions conducted in a first region; generate at least one metric based at least partially on the transaction data; determine, based at least partially on the at least one metric, that the first region is underserved; generate at least one score for the first region based at least partially on the at least one metric; and correlate the at least one score with demographic data associated with the first region.

In non-limiting embodiments of the system, determining the at least one metric comprises: determining a number of transactions in a category within the first region or conducted by account holders associated with the first region; determining a number of merchants within the first region that are associated with the category and are located within the first region; and generating the at least one metric based on the number of transactions and the number of merchants. In non-limiting embodiments, determining the at least one metric further comprises: determining a population in the first region; determining a number of merchants within the first region that are associated with a category and are located within the first region; and generating the at least one metric based on a ratio of the population to the number of merchants.

In non-limiting embodiments of the system, determining that the merchants are located within the first region comprises: correlating a geographic code embedded in transaction data from each merchant with a geographic boundary of the first region; or correlating merchant identifiers associated with transactions in the category with a merchant database associating merchant identifiers with geographic codes. In non-limiting embodiments, determining the at least one score for the first region comprises inputting, into a score generation algorithm, the number of transactions in the category and the number of merchants.

In non-limiting embodiments of the system, the at least one metric represents a number of merchants in the first region that correspond to a predetermined Merchant Category Code (MCC). In other non-limiting embodiments, the at least one metric represents a number of banks having a Bank Identification Number (BIN) corresponding to the first region.

According to another non-limiting embodiment, provided is a computer program product for determining underserved regions based on transaction data, comprising at least one non-transitory computer-readable medium including program instructions that, when executed by at least one processor, cause the at least one processor to: receive transaction data associated with a plurality of transactions conducted in a first region; generate at least one metric based at least partially on the transaction data; determine, based at least partially on the at least one metric, that the first region is underserved; generate at least one score for the first region based at least partially on the at least one metric; and correlate the at least one score with demographic data associated with the first region.

In non-limiting embodiments of the computer program product, determining the at least one metric comprises: determining a number of transactions in a category within the first region or conducted by account holders associated with the first region; determining a number of merchants within the first region that are associated with the category and are located within the first region; and generating the at least one metric based on the number of transactions and the number of merchants. In non-limiting embodiments, determining the at least one metric further comprises: determining a population in the first region; determining a number of merchants within the first region that are associated with a category and are located within the first region; and generating the at least one metric based on a ratio of the population to the number of merchants.

In non-limiting embodiments of the computer program product, determining that the merchants are located within the first region comprises: correlating a geographic code embedded in transaction data from each merchant with a geographic boundary of the first region; or correlating merchant identifiers associated with transactions in the category with a merchant database associating merchant identifiers with geographic codes. In non-limiting embodiments, determining the at least one score for the first region comprises inputting, into a score generation algorithm, the number of transactions in the category and the number of merchants.

In non-limiting embodiments of the computer program product, the at least one metric represents a number of merchants in the first region that correspond to a predetermined Merchant Category Code (MCC). In other non-limiting embodiments, the at least one metric represents a number of banks having a Bank Identification Number (BIN) corresponding to the first region.

Further embodiments or aspects are set forth in the following numbered clauses:

Clause 1: A computer-implemented method for determining underserved regions based on transaction data, comprising: receiving, with at least one processor, transaction data associated with a plurality of transactions conducted in a first region; generating, with at least one processor, at least one metric based at least partially on the transaction data; determining, with at least one processor and based at least partially on the at least one metric, that the first region is underserved; generating, with at least one processor, at least one score for the first region based at least partially on the at least one metric; and correlating, with at least one processor, the at least one score with demographic data or map data associated with the first region.

Clause 2: The computer-implemented method of clause 1, wherein determining the at least one metric comprises: determining a number of transactions in a category within the first region or conducted by account holders associated with the first region; determining a number of merchants within the first region that are associated with the category and are located within the first region; and generating the at least one metric based on the number of transactions and the number of merchants.

Clause 3: The computer-implemented method of clauses 1 or 2, wherein determining the at least one metric further comprises: determining a population in the first region; determining a number of merchants within the first region that are associated with a category and are located within the first region; and generating the at least one metric based on a ratio of the population to the number of merchants.

Clause 4: The computer-implemented method of any of clauses 1-3, wherein determining that the merchants are located within the first region comprises: correlating a geographic code embedded in transaction data from each merchant with a geographic boundary of the first region; or correlating merchant identifiers associated with transactions in the category with a merchant database associating merchant identifiers with geographic codes.

Clause 5: The computer-implemented method of any of clauses 1-4, wherein determining the at least one score for the first region comprises inputting, into a score generation algorithm, the number of transactions in the category and the number of merchants.

Clause 6: The computer-implemented method of any of clauses 1-5, wherein the at least one metric represents a number of merchants in the first region that correspond to a predetermined Merchant Category Code (MCC).

Clause 7: The computer-implemented method of any of clauses 1-6, wherein the at least one metric represents a number of banks having a Bank Identification Number (BIN) corresponding to the first region.

Clause 8: A system for determining underserved regions based on transaction data, comprising: at least one data storage device comprising transaction data; and at least one processor in communication with the at least one data storage device, the at least one processor programmed or configured to: receive transaction data associated with a plurality of transactions conducted in a first region; generate at least one metric based at least partially on the transaction data; determine, based at least partially on the at least one metric, that the first region is underserved; generate at least one score for the first region based at least partially on the at least one metric; and correlate the at least one score with demographic data associated with the first region.

Clause 9: The system of clause 8, wherein determining the at least one metric comprises: determining a number of transactions in a category within the first region or conducted by account holders associated with the first region; determining a number of merchants within the first region that are associated with the category and are located within the first region; and generating the at least one metric based on the number of transactions and the number of merchants.

Clause 10: The system of clauses 8 or 9, wherein determining the at least one metric comprises: determining a population in the first region; determining a number of merchants within the first region that are associated with a category and are located within the first region; and generating the at least one metric based on a ratio of the population to the number of merchants.

Clause 11: The system of any of clauses 8-10, wherein determining that the merchants are located within the first region comprises: correlating a geographic code embedded in transaction data from each merchant with a geographic boundary of the first region; or correlating merchant identifiers associated with transactions in the category with a merchant database associating merchant identifiers with geographic codes.

Clause 12: The system of any of clauses 8-11, wherein determining the at least one score for the first region comprises inputting, into a score generation algorithm, the number of transactions in the category and the number of merchants.

Clause 13: The system of any of clauses 8-12, wherein the at least one metric represents a number of merchants in the first region that correspond to a predetermined Merchant Category Code (MCC).

Clause 14: The system of any of clauses 8-13, wherein the at least one metric represents a number of banks having a Bank Identification Number (BIN) corresponding to the first region.

Clause 15: A computer program product for determining underserved regions based on transaction data, comprising at least one non-transitory computer-readable medium including program instructions that, when executed by at least one processor, cause the at least one processor to: receive transaction data associated with a plurality of transactions conducted in a first region; generate at least one metric based at least partially on the transaction data; determine, based at least partially on the at least one metric, that the first region is underserved; generate at least one score for the first region based at least partially on the at least one metric; and correlate the at least one score with demographic data associated with the first region.

Clause 16: The computer program product of clause 15, wherein determining the at least one metric comprises: determining a number of transactions in a category within the first region or conducted by account holders associated with the first region; determining a number of merchants within the first region that are associated with the category and are located within the first region; and generating the at least one metric based on the number of transactions and the number of merchants.

Clause 17: The computer program product of clauses 15 or 16, wherein determining the at least one metric comprises: determining a population in the first region; determining a number of merchants within the first region that are associated with a category and are located within the first region; and generating the at least one metric based on a ratio of the population to the number of merchants.

Clause 18: The computer program product of any of clauses 15-17, wherein determining that the number of merchants are located within the first region comprises: correlating a geographic code embedded in transaction data from each merchant with a geographic boundary of the first region; or correlating merchant identifiers associated with transactions in the category with a merchant database associating merchant identifiers with geographic codes.

Clause 19: The computer program product of any of clauses 15-18, wherein determining the at least one score for the first region comprises inputting, into a score generation algorithm, the number of transactions in the category and the number of merchants.

Clause 20: The computer program product of any of clauses 15-19, wherein the at least one metric represents a number of merchants in the first region that correspond to a predetermined Merchant Category Code (MCC).

Clause 21: The computer program product of any of clauses 15-20, wherein the at least one metric represents a number of banks having a Bank Identification Number (BIN) corresponding to the first region.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying figures, in which:

FIG. 1 is a schematic diagram of a system for determining underserved regions based on transaction data according to a non-limiting embodiment;

FIG. 2A is a flow diagram of a method for determining underserved regions based on transaction data according to a non-limiting embodiment; and

FIG. 2B is a flow diagram of a method for determining underserved regions based on transaction data according to another non-limiting embodiment; and

FIG. 3 is a diagram of a non-limiting embodiment of components of one or more devices of FIG. 1.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction service provider system” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “issuer institution” may refer to one or more entities, such as a bank, that provide accounts to customers for conducting payment transactions, such as initiating credit and/or debit payments. For example, an issuer institution may provide an account identifier, such as a personal account number (PAN), to a customer that uniquely identifies one or more accounts associated with that customer. The account identifier may be embodied on a physical financial instrument, such as a payment card, and/or may be electronic and used for electronic payments. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes. An issuer institution may be associated with a BIN or other unique identifier that uniquely identifies it among other issuer institutions.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a mobile device executing an electronic wallet application, a personal digital assistant, a security card, an access card, a wireless terminal, and/or a transponder, as examples. The portable financial device may include a volatile or a non-volatile memory to store information, such as an account identifier or a name of the account holder.

As used herein, the term “underserved region” refers to a region in which a ratio of account holders (e.g., portable financial device users) to one or more merchants (e.g., such as a store or service provider), categories of merchants (e.g., grocery stores, pharmacies, etc.), financial institutions (e.g., banks), or other entities satisfies a determined threshold or exceeds a threshold for normalcy by a determined amount. For example, a region may be underserved for a given category of merchants if the ratio of account holders in that region to a total number of merchants in that category exceeds 1,000. The thresholds may be specified by a user, by a governmental authority, by a transaction service provider, or by any other entity or entities.

As used herein, the term “region” may refer to any geographic area. As an example, a region may be a geographic area defined by a zip or postal code, a range or plurality of zip or postal codes, a town or city, a county, a state, and/or the like. It will be appreciated that a region may also be a geographic area defined arbitrarily by any bounding perimeters as specified on a map, by longitude and latitude, or by any other means.

In non-limiting embodiments, provided is a system, method, and computer program product for determining underserved regions based on transaction data that provides technical advantages over existing manual, operator-driven approaches. By uniquely combining data sources, including transaction data across multiple consumers, merchants, and service providers, non-limiting embodiments provide for new algorithms and approaches for identifying underserved regions, generating interactive user interfaces, and automatically improving services and offerings.

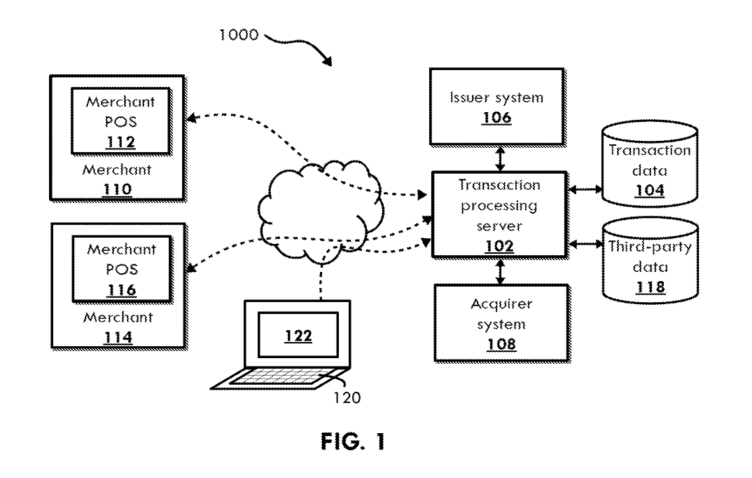

Referring now to FIG. 1, a system 1000 for determining underserved regions based on transaction data is shown according to a non-limiting embodiment. Merchants 110, 114 may include merchant POS systems 112, 116 for conducting transactions with users. As an example, a user wishing to conduct a transaction with a merchant 110 for goods and/or services may present a portable financial device to the merchant POS system 112. The merchant POS systems 112, 116 are in communication with a transaction processing server 102 via a network environment. The merchant POS systems 112, 116 may communicate with the transaction processing server 102 directly or, in other examples, via a payment gateway, an acquirer system 108, and/or other systems.

With continued reference to FIG. 1, the transaction processing server 102 may receive transaction requests, associated with transactions, from the merchant POS systems 112, 116 and may process the transactions with an issuer system 106 and an acquirer system 108. Transaction data associated with a transaction may be stored in a transaction database 104 that is in communication with the transaction processing server 102. Transaction data may include any data associated with the transaction such as, but not limited to, a transaction value, a transaction count, an MCC, a merchant identifier, a user identifier, an account identifier, a transaction time, a transaction date, a merchant location, a transaction type (e.g., Card-Present or Card-Not-Present), and/or any other like data concerning the transaction and/or any other like data concerning any party to the transaction. In some non-limiting embodiments, transaction data may also include data associated with transactions that were not processed by the transaction processing server 102 but rather by a different transaction processing server (not shown in FIG. 1).

Still referring to FIG. 1, the transaction processing server 102 may be in communication with one or more third-party databases 118 and systems. The third-party database 118 may include, for example, demographic data for different regions, census data for different regions, government benefit data for different regions and/or individuals, and/or other like data. In non-limiting embodiments, the third-party database 118 may be a government database. Further, as explained above, a third-party database 118 may also include additional transaction data processed by another transaction processing server or payment network.

Non-limiting embodiments of the system 1000 process transaction data from the transaction database 104 and third-party data from one or more third-party databases 118 to determine regions that are underserved. The transaction data and/or third-party data may be analyzed by one or more algorithms to determine one or more underserved regions. In non-limiting embodiments, the transaction processing server 102 or another processor is in communication with a user computer 120 that presents one or more graphical user interfaces (GUIs) 122 through a software application and/or website, as examples. A user, through the GUI 122, specifies one or more categories using selectable options. Selectable options may include, for example, checkboxes, buttons, drop-down menus, hyperlinks, text boxes, and/or the like. For example, a user may select “grocery store” or “bank” as a category. In some examples, a user may specify an MCC. Additionally, in some non-limiting embodiments, a user may also specify one or more geographic regions by inputting or selecting, for example, one or more zip or postal codes. It will be appreciated that, in other non-limiting examples, such parameters may be predefined and/or preselected by the system 1000.

In non-limiting embodiments, an algorithm for determining one or more underserved regions receives, as inputs, one or more of the following transaction parameters from cleared and settled purchase transactions, automated teller machine (ATM) transactions, and transactions conducted using electronic benefit transfer (EBT) payment networks: an identifier of the EBT payment network, a merchant country code, a merchant name, a merchant city, a merchant street, a merchant postal code, a merchant geographic identifier, an MCC, a transaction amount, a transaction count, and/or any other transaction parameter. In non-limiting embodiments, these variables may be identified as: ntwrk_id, tran_cd, mrch_ctry_cd, mrch_nm_raw, mrch_city_nm_raw, mrch_st_cd_raw, mrch_pstl_cd_raw, mrch_geo_pstl_cd, mrch_geo_id, mrch_gmr_id, mrch_catg_cd, cs_tran_amt, and cs_tran_cnt.

In non-limiting embodiments, the algorithm for determining one or more underserved regions receives, as inputs, one or more of the following transaction parameters from cleared and settled purchases and ATM transactions from the transaction service provider associated with the transaction processing server 102: an identifier of the payment network, an acquirer institution identifier (e.g., a BIN), an issuer institution identifier (e.g., a BIN), a merchant country code, a merchant name, a merchant city, a merchant street, a merchant postal code, a merchant geographic identifier, an MCC, a transaction amount, a transaction count, and/or any other transaction parameter. In non-limiting embodiments, these variables may be defined as ntwrk_id, tran_cd, acqr_bin, issr_bin, mrch_ctry_cd, mrch_nm_raw, mrch_city_nm_raw, mrch_st_cd_raw, mrch_pstl_cd_raw, mrch_geo_pstl_cd, mrch_geo_id, mrch_gmr_id, mrch_catg_cd, cs_tran_amt, and cs_tran_cnt.

In non-limiting embodiments, the algorithm for determining one or more underserved regions receives, as inputs, one or more parameters from the transaction database 104 and/or the third-party database 118. This may include, for example, bank locations (determined, for example, based on customer data available to the transaction processing server 102), demographic information (e.g., population, family size, income, race, age, gender, etc.), regional information (e.g., geographic features, size, area, etc., for a region), and/or any other like parameters.

In non-limiting embodiments, the transaction processing server 102 is programmed or configured to determine metrics from payment network transactions including, but not limited to, transactions conducted with the transaction service provider associated with the transaction processing server 102, an interbank network (e.g., Interlink, Plus, etc.), and/or the like. As an example, the transaction processing server 102 may determine an average number of grocery store locations per person in each region (e.g., in each zip code or other regional boundary) based on the payment network identifier, the MCC(s) for grocery stores, the merchant geographic identifier, and other parameters. The transaction processing server 102 may also determine an average number of bank locations per person in each region based on bank identifiers (e.g., BINs) and customer data available to the transaction processing server 102 (e.g., data from the Visa Client Information System (VCIS)).

In non-limiting embodiments, the transaction processing server 102 is programmed or configured to determine metrics for payment network transactions such as, for example, average or median transaction values, transaction volumes, and/or the like.

In non-limiting embodiments, the transaction processing server 102 is programmed or configured to determine one or more regions that are underserved for a given service and/or merchant. To do so, the transaction processing server 102 may compare one or more metrics to one or more thresholds. The thresholds may be predefined, specified by a user, dynamically determined, retrieved from a third-party database, and/or the like. For example, the number of grocery stores in a given region may be compared to a threshold value representing an average number of grocery store locations for a larger region (e.g., a state or country including the region), an average number of grocery store locations for a different region than the given region, and/or a specified input from a user. If the number of grocery store locations in a given region is less than a threshold or comparison value, the region may be classified as underserved with respect to grocery stores. In some non-limiting embodiments, the region may be classified as underserved if the number of grocery store locations is at least a predetermined value less than an average number of grocery store locations. The average number of grocery store locations may be, in some examples, an average number of grocery store locations that accept government benefit transactions.

As another example, the number of banks in a given region may be compared to an average number of bank locations for a larger region (e.g., a state or country including the region), an average number of bank locations for a different region than the given region, and/or a specified threshold value of bank locations for a region. If the number of banks in a given region is less than a threshold or comparison value, the region may be classified as underserved with respect to banks. In some non-limiting embodiments, the region may be classified as underserved if the number of bank locations is at least a predetermined value less than an average number of bank locations.

In non-limiting embodiments, one or more scoring algorithms may be applied to generate a score for a region and the score may represent the degree of how underserved that region is. For example, all regions having one or more metrics that fail to satisfy a threshold may be scored based on a combination of the metrics. As an example, the metrics may be normalized, averaged, summed, and/or the like to create a score. Scoring criteria may be defined in various ways and with various weights attributed to different parameters. The scores may be output in one or more lists, databases, or other data structures. The scores may also be used to generate a heat map to illustrate different regions and the different scores associated with those regions.

In non-limiting embodiments, the scores generated for the underserved regions may be correlated with demographic data. For example, one or more reports may be generated to correlate underserved regions with the population age, race, ethnicity, employment status, and/or the like. In this manner, regions at risk of harm to the population can be quickly identified and addressed.

In non-limiting embodiments, one or more automatic actions may be performed in response to generating a score for a region. For example, regions with scores satisfying a threshold may be automatically identified and data associated with the regions may be communicated to one or more merchants or banks.

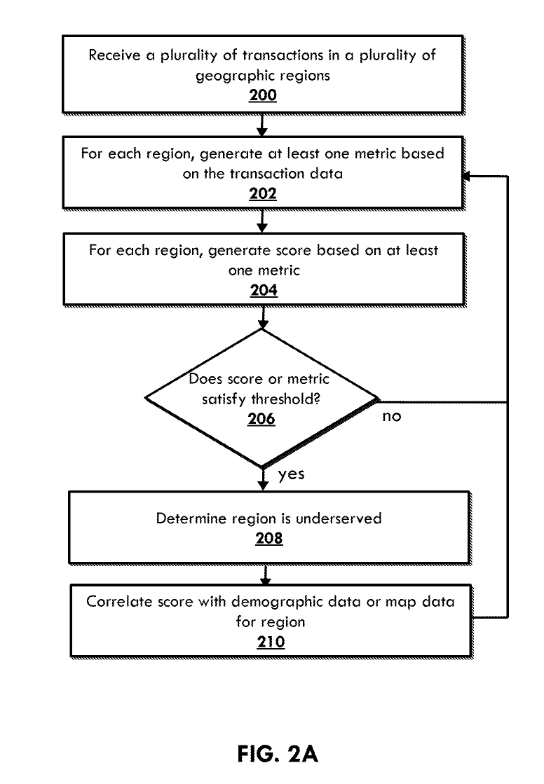

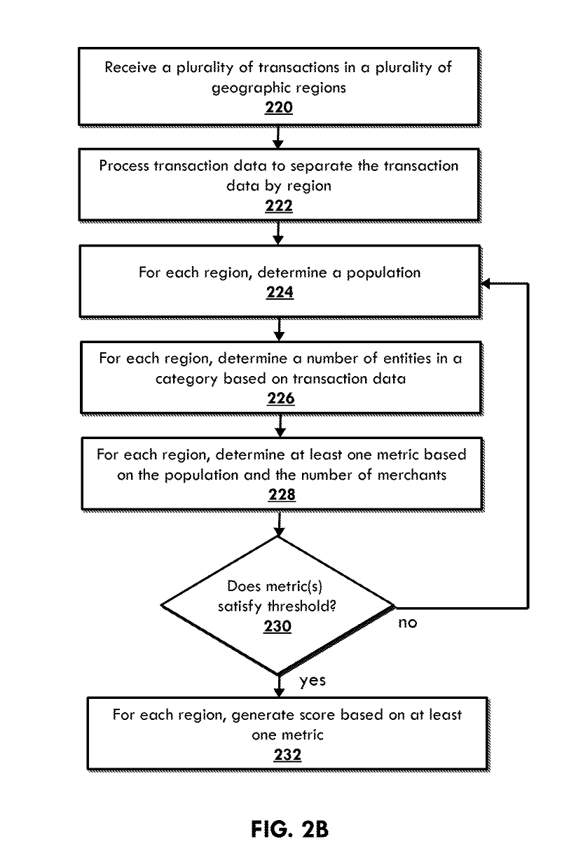

Referring now to FIG. 2A, a flow diagram of a method for determining an underserved region is shown according to a non-limiting embodiment. At a first step 200, a plurality of transactions is received from a plurality of geographic regions. The plurality of transactions may be transactions processed by a transaction processing server within an electronic payment network and/or may be from other sources. At step 202, at least one metric is generated based on the transaction data from the plurality of transactions received at step 200. A metric may include, for example, a ratio of individuals in a population to a number of merchants or service providers for a given zip code. A metric may also include a ratio of account holders to a number of merchants or service providers for the zip code. The metric may be determined by processing the transaction data based on a region and category, as an example. In an example in which the category is grocery stores, the transaction data may be queried and parsed to identify all transactions from a specified region having an MCC that matches grocery stores. In an example in which the category is banks, the transaction data may be queried and parsed to identify all transactions having BINs that match banks located in a specified region. Additional databases, such as merchant databases and financial institution databases, may also be queried to cross reference information such as all BINs associated with a specified location or all merchant identifiers associated with a specified location.

Still referring to FIG. 2A, at step 204, a score is generated based on the at least one metric generated at step 202. Although FIG. 2A shows that step 204 occurs before steps 206 and 208, it will be appreciated that a score may be generated after determining, based on the at least one metric, that the region is underserved. It will be appreciated that other variations are possible. In some examples, the score may be the metric(s) after being rounded or normalized. In other examples, the score may be the product of an algorithm that receives, as an input, at least the metric(s). For example, generating a score may include combining the metric(s), averaging the metric(s), normalizing the metric(s) over a specified range, and/or the like.

With continued reference to FIG. 2A, at step 206, it is determined if the score or metric(s) satisfies a threshold. As explained above, either the score or the metric(s) used to generate the score may be compared to a threshold. The threshold(s) may be predefined, specified by a user, dynamically determined, retrieved from a third-party database, and/or the like. For example, the threshold may be an average number of merchants or service providers in a larger region (that includes the region), an average number of merchants or service providers in another region or regions, a predetermined or preselected threshold, a dynamic threshold, and/or the like. If, at step 206, it is determined that the score or metric satisfies the threshold (e.g., meets, exceeds, is less than, etc.), the method proceeds to step 208 and it is determined that the region is underserved. As an example, the region may be stored in a database with an identifier indicating that it was determined to be underserved, the metric(s), and/or the score. If, at step 206, it is determined that the score or metric does not satisfy the threshold, the method may stop or loop back to step 202 and generate a metric for another region.

Still referring to FIG. 2A, at step 210, after it is determined that the region is underserved, the system may correlate the score with demographic data and/or map data for the region. For example, multiple scores and/or multiple metrics for multiple regions may also be used to generate a heat map to illustrate different regions and the different scores associated with those regions. As another example, one or more reports may be generated to correlate underserved regions with demographic data such as the population age, race, ethnicity, employment status, and/or the like. The system may receive such map data and/or demographic data from one or more third-party databases, government agencies, and/or the like.

Referring now to FIG. 2B, a flow diagram of a method for determining an underserved region is shown according to another non-limiting embodiment. At a first step 220, a plurality of transactions is received from a plurality of geographic regions. The plurality of transactions may be transactions processed by a transaction processing server within an electronic payment network and/or may be from other sources. At step 222, the transaction data is processed based on region, such as zip or postal code, where the transaction took place. This may be determined directly from the transaction data if made available or, in examples where the geographic location is not indicated by the transaction data, may involve identifying one or more merchant identifiers and or BINs, or other identifiers, from each transaction and correlating such identifiers to a geographic region based on a query of another database, such as a merchant or financial institution database, that associates merchants and/or financial institutions with regions.

Still referring to FIG. 2B, at step 224, a population metric is determined for a region. The population may be determined from actual population data, such as data obtained from a census database, or may be determined based on a total number of account holders associated with addresses within the region. In other non-limiting examples, the population may also include account holders that transact in the region but may not reside there, such as account holders that may frequently visit, work in, or otherwise spend time in that region. At step 226, a metric representing a number of entities in that region is determined based on the transaction data. For example, a total number of merchants matching a specified MCC may be determined by identifying transactions having the specified MCC, correlating the merchant identifiers for each of those transactions with a merchant database that associated merchant identifiers with location(s), and identifying merchants that are located in that region that match the specified MCC. As another example, a total number of banks within a region may be identified by correlating BINs for each transaction with a database that associates bank location(s) with BINs.

Still referring to FIG. 2B, at step 228, at least one metric is determined based on the metrics already determined, including the population metric and the number of entities. For example, the at least one metric may include a ratio of population to the number of entities. It will be appreciated that various algorithms may be utilized to determine one or more metrics based on underlying metrics and inputs such as population and number of entities. At step 230, the one or more metrics are compared to one or more specified thresholds. For example, the ratio of population to number of entities may be compared to one or more threshold values. If, at step 230, it is determined that the metric satisfies the threshold (e.g., meets, exceeds, is less than, etc.), it is determined that the region is underserved and the method proceeds to step 232 in which a score is generated based on the one or more metrics. If, at step 230, it is determined that the score does not satisfy the threshold, the method may stop or loop back to step 224 and repeat steps 224 through 230 for another region. It will be appreciated that, at step 230, the metric may be compared to the threshold rather than the score. It will also be appreciated that a score may be determined for each region regardless of whether the one or more metrics exceeds a threshold at step 230.

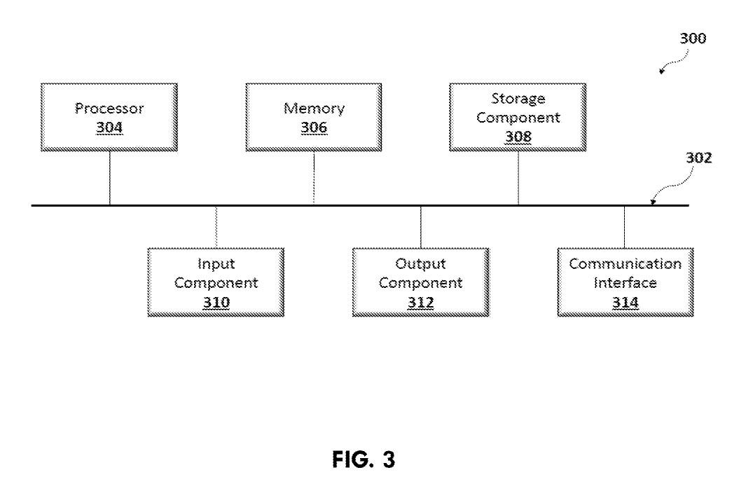

Referring now to FIG. 3, shown is a diagram of example components of a device 300 according to non-limiting embodiments. Device 300 may correspond to transaction processing server 102, issuer system 106, acquirer system 108, merchant systems 110, 114, user computer 120, and/or data storage devices 104, 118 in FIG. 1. In some non-limiting embodiments, transaction processing server 102, issuer system 106, acquirer system 108, merchant systems 110, 114, user computer 120, and/or data storage devices 104, 118 may include at least one device 300 and/or at least one component of device 300. As shown in FIG. 3, device 300 may include a bus 302, a processor 304, memory 306, a storage component 308, an input component 310, an output component 312, and a communication interface 314.

Bus 302 may include a component that permits communication among the components of device 300. In some non-limiting embodiments, processor 304 may be implemented in hardware, firmware, or a combination of hardware and software. For example, processor 304 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 306 may include random access memory (RAM), read only memory (ROM), and/or another type of dynamic or static storage device (e.g., flash memory, magnetic memory, optical memory, etc.) that stores information and/or instructions for use by processor 304.

Storage component 308 may store information and/or software related to the operation and use of device 300. For example, storage component 308 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 310 may include a component that permits device 300 to receive information, such as via user input (e.g., a touch screen display, a keyboard, a keypad, a mouse, a button, a switch, a microphone, etc.). Additionally or alternatively, input component 310 may include a sensor for sensing information (e.g., a global positioning system (GPS) component, an accelerometer, a gyroscope, an actuator, etc.). Output component 312 may include a component that provides output information from device 300 (e.g., a display, a speaker, one or more light-emitting diodes (LEDs), etc.).

Communication interface 314 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 314 may permit device 300 to receive information from another device and/or provide information to another device. For example, communication interface 314 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 300 may perform one or more processes described herein. Device 300 may perform these processes based on processor 304 executing software instructions stored by a computer-readable medium, such as memory 306 and/or storage component 308. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 306 and/or storage component 308 from another computer-readable medium or from another device via communication interface 314. When executed, software instructions stored in memory 306 and/or storage component 308 may cause processor 304 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 3 are provided as an example. In some non-limiting embodiments, device 300 may include additional components, fewer components, different components, or differently arranged components than those shown in FIG. 3. Additionally or alternatively, a set of components (e.g., one or more components) of device 300 may perform one or more functions described as being performed by another set of components of device 300.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for determining underserved regions based on transaction data, comprising:
receiving, with at least one processor, transaction data associated with a plurality of transactions conducted in a first region;
generating, with at least one processor, at least one metric based at least partially on the transaction data;
determining, with at least one processor and based at least partially on the at least one metric, that the first region is underserved;
generating, with at least one processor, at least one score for the first region based at least partially on the at least one metric; and
correlating, with at least one processor, the at least one score with demographic data or map data associated with the first region.

2. The computer-implemented method of claim 1, wherein determining the at least one metric comprises:
determining a number of transactions in a category within the first region or conducted by account holders associated with the first region;
determining a number of merchants within the first region that are associated with the category and are located within the first region; and
generating the at least one metric based on the number of transactions and the number of merchants.

3. The computer-implemented method of claim 1, wherein determining the at least one metric further comprises:
determining a population in the first region;
determining a number of merchants within the first region that are associated with a category and are located within the first region; and
generating the at least one metric based on a ratio of the population to the number of merchants.

4. The computer-implemented method of claim 3, wherein determining that the merchants are located within the first region comprises: correlating a geographic code embedded in transaction data from each merchant with a geographic boundary of the first region; or correlating merchant identifiers associated with transactions in the category with a merchant database associating merchant identifiers with geographic codes.

5. The computer-implemented method of claim 2, wherein determining the at least one score for the first region comprises inputting, into a score generation algorithm, the number of transactions in the category and the number of merchants.

6. The computer-implemented method of claim 1, wherein the at least one metric represents a number of merchants in the first region that correspond to a predetermined Merchant Category Code (MCC).

7. The computer-implemented method of claim 1, wherein the at least one metric represents a number of banks having a Bank Identification Number (BIN) corresponding to the first region.

8. A system for determining underserved regions based on transaction data, comprising:
at least one data storage device comprising transaction data; and
at least one processor in communication with the at least one data storage device, the at least one processor programmed or configured to:
receive transaction data associated with a plurality of transactions conducted in a first region;
generate at least one metric based at least partially on the transaction data;
determine, based at least partially on the at least one metric, that the first region is underserved;
generate at least one score for the first region based at least partially on the at least one metric; and
correlate the at least one score with demographic data associated with the first region.

9. The system of claim 8, wherein determining the at least one metric comprises:
determining a number of transactions in a category within the first region or conducted by account holders associated with the first region;
determining a number of merchants within the first region that are associated with the category and are located within the first region; and
generating the at least one metric based on the number of transactions and the number of merchants.

10. The system of claim 8, wherein determining the at least one metric comprises:
determining a population in the first region;
determining a number of merchants within the first region that are associated with a category and are located within the first region; and
generating the at least one metric based on a ratio of the population to the number of merchants.

11. The system of claim 9, wherein determining that the merchants are located within the first region comprises: correlating a geographic code embedded in transaction data from each merchant with a geographic boundary of the first region; or correlating merchant identifiers associated with transactions in the category with a merchant database associating merchant identifiers with geographic codes.

12. The system of claim 11, wherein determining the at least one score for the first region comprises inputting, into a score generation algorithm, the number of transactions in the category and the number of merchants.

13. The system of claim 8, wherein the at least one metric represents a number of merchants in the first region that correspond to a predetermined Merchant Category Code (MCC).

14. The system of claim 8, wherein the at least one metric represents a number of banks having a Bank Identification Number (BIN) corresponding to the first region.

15. A computer program product for determining underserved regions based on transaction data, comprising at least one non-transitory computer-readable medium including program instructions that, when executed by at least one processor, cause the at least one processor to:
receive transaction data associated with a plurality of transactions conducted in a first region;
generate at least one metric based at least partially on the transaction data;
determine, based at least partially on the at least one metric, that the first region is underserved;
generate at least one score for the first region based at least partially on the at least one metric; and
correlate the at least one score with demographic data associated with the first region.

16. The computer program product of claim 15, wherein determining the at least one metric comprises:
determining a number of transactions in a category within the first region or conducted by account holders associated with the first region;
determining a number of merchants within the first region that are associated with the category and are located within the first region; and
generating the at least one metric based on the number of transactions and the number of merchants.

17. The computer program product of claim 15, wherein determining the at least one metric comprises:
determining a population in the first region;
determining a number of merchants within the first region that are associated with a category and are located within the first region; and
generating the at least one metric based on a ratio of the population to the number of merchants.

18. The computer program product of claim 16, wherein determining that the number of merchants are located within the first region comprises: correlating a geographic code embedded in transaction data from each merchant with a geographic boundary of the first region; or correlating merchant identifiers associated with transactions in the category with a merchant database associating merchant identifiers with geographic codes.

19. The computer program product of claim 18, wherein determining the at least one score for the first region comprises inputting, into a score generation algorithm, the number of transactions in the category and the number of merchants.

20. The computer program product of claim 15, wherein the at least one metric represents a number of merchants in the first region that correspond to a predetermined Merchant Category Code (MCC).

21. The computer program product of claim 15, wherein the at least one metric represents a number of banks having a Bank Identification Number (BIN) corresponding to the first region.
